(19) United States
(12) Patent Application Publication
(10) Pub. No.: US 2006/0210670 A1
(43) Pub. Date: Sep. 21, 2006

(54) Kimchi containing puerh tea leaves

(76) Inventor: Taik Young Yoon, Pocheon-city (KR)

Correspondence Address: LADAS & PARRY LLP, 224 SOUTH MICHIGAN AVENUE, SUITE 1600, CHICAGO, IL, 60604, US

(21) Appl. No.: 11/214,260

(22) Filed: Aug. 29, 2005

(30) Foreign Application Priority Data
Mar. 16, 2005 (KR) 10-2005-0021879

(51) Int. Cl. A23B 7/10

(52) U.S. Cl. 426/49

(57) ABSTRACT

Kimchi containing 0.001-15% by weight of puerh tea leaves based on the total weight of the kimchi is provided. The kimchi containing puerh tea leaves does not undergo flavor changes, such as souring, and texture degradation. In addition, the puerh tea leaves in the kimchi remove off-flavors produced during fermentation, thereby maintaining fresh and mild taste of the kimchi.

### BACKGROUND OF THE INVENTION

This application claims the priority of Korean Patent Application No. 10-2005-0021879, filed on Mar. 16, 2005, in the Korean Intellectual Property Office, the disclosure of which is incorporated herein in its entirety by reference.

1. Field of the Invention

The present invention relates to kimchi containing puerh tea leaves.

2. Description of the Related Art

Puerh tea is made from large tea leaves produced in the southern region of China, particularly, Yunnan province. Puerh tea is a post-fermented tea obtained through microbial fermentation. When brewed, puerh tea has a reddish brown color, like black tea, does not taste astringent, and has a unique flavor.

In modern medicine, it has been found through field studies that puerh tea is beneficial based on the fact that nomadic tribes near the Chinese border who eat greasy goods, such as meat, etc., are healthy.

Old documents record the pharmaceutical effects of puerh tea. For example, [symbol] (“Selection of the Outline Treatise of Medical Herbs”) records that “puerh tea has a unique flavor, cures hangovers, facilitates digestion, dissolves phlegm, eliminates harmful body fat, protects the guts, and generates vital liquid.

According to the Medical Encyclopedia of China, puerh tea contains components that pick up warm energy and has no toxicity. Puerh tea facilitates digestion, saliva and body fluids secretion, and gas elimination, cures a hangover after drinking, removes phlegm, removes heat in the larynx, causes sweat when taken together with ginger, and removes harmful cold energy.

According to the records in [symbol] (Journal of Yunnan Province), [symbol] (Book of hundreds of flowers), etc., puerh tea eliminates harmful oiliness, cleans the guts, sobers a person, facilitates digestion, generates vital liquid, cures sore throats, cures baby colic when taken together with a ginger soup, and stops bleeding.

Recently, the Paris Academy of Medicine has proved through clinical tests that puerh tea leaves can effectively reduce body weight, prevent fat synthesis, facilitate metabolism, and enhance digestion.

In addition, as a result of clinical tests in China, it has been found that puerh tea can markedly lower body fat content and cholesterol levels. Cholesterol levels were reduced by about 22% after steady usage for 1 month.

In a research report entitled “Effects of puerh tea on the sclerosis of the arteries and the oxidation of low-density lipoprotein (LDL) cholesterol,” by the Food Science and Technology Research Institute of National Taiwan University, it was found that such pharmaceutical effects of puerh tea, like green tea, black tea, etc., originate from the fermentation process which occurs while in storage and produces microorganisms and various kinds of unique aromas and flavors.

It is also known that puerh tea kills cancer cells, like green tea, and has a stronger anticancer effect than green tea. In particular, when dropped in a beaker containing cancer cells, puerh tea reduces, deforms, and finally kills the cancer cells.

As described above, puerh tea is consumed not only to enjoy its aroma. Puerh tea has strong pharmaceutical effects, such as cholesterol level reduction, body fat decomposition, and immunity enhancement, and thus is recognized as a health tea or a diet tea.

However, puerh tea leaves have been used only to produce tea through brewing and has never been used in foods. In addition, only the above-described pharmaceutical effects of puerh tea are known, and its effects when used in foods have not been disclosed.

Examples of the use of puerh tea leaves in foods are disclosed in Korean Laid-open Patent Publication No. 2003-0084036 (Nov. 1, 2003), entitled “Puerh tea composition with antiobesity and anticholesterol effects”, Korean Laid-open Patent Publication No. 2001-69898 (Jul. 25, 2001), entitled “Antihangover beverage using puerh tea”, etc. However, in the above-identified patent applications, only the use of puerh tea leaves in the form of brewed beverages, not in foods, is described and the above-described pharmaceutical effects of puerh tea are disclosed. Other uses of puerh tea leaves have not been disclosed.

The inventors of this invention found that puerh tea leaves effectively retard the souring of kimchi when added to kimchi and improve the flavor of kimchi by removing off-flavors of kimchi, and completed the present invention.

### SUMMARY OF THE INVENTION

The present invention discloses new effects of puerh tea leaves when used in foods, in particular, in kimchi, and provides kimchi containing puerh tea leaves and a method of preparing the same.

According to an aspect of the present invention, there is provided kimchi prepared using vegetables, the kimchi containing 0.001-15% by weight of puerh tea leaves based on the total weight of the kimchi.

According to another aspect of the present invention, there is provided a method of preparing kimchi containing puerh tea leaves, the method comprising: soaking vegetables in saline water; mixing the vegetables with puerh tea leaves and common kimchi spices; and fermenting the mixture.

### DETAILED DESCRIPTION OF THE INVENTION

Kimchi containing puerh tea leaves and a method of preparing the same according to embodiments of the present invention will be described in detail.

Vegetables that can be used in kimchi according to an embodiment of the present invention include, but are not limited to, Chinese cabbage, radishes, young radishes, mustard greens, western cabbage, winter-grown vegetables, cucumbers, lettuce, leeks, etc.

Any kind of commercially available puerh tea leaves can be used to obtain the same effect.

The present invention can be applied to any kind of kimchi prepared by fermenting salted vegetables, for example, but not limited to, Chinese cabbage kimchi, cubed radish kimchi (Kakdugi), young radish kimchi, mustard green kimchi, white cabbage kimchi, western cabbage kimchi, winter-grown vegetable kimchi, radish kimchi in water (Dongchimi), cabbage kimchi in water, stuffed cucumber pickles, lettuce kimchi, leek kimchi, cucumbers pickled in salt, etc.

A method of preparing kimchi according to an embodiment of the present invention further includes adding puerh tea leaves when mixing spices together, compared with conventional kimchi preparation methods. In particular, in the kimchi preparation method according to the present embodiment, after soaking the vegetables in a salt solution, common spices used in kimchi are mixed with puerh tea leaves and fermented. Common spices used in kimchi include salt, red pepper powder, shredded radish, garlic, ginger root, salted shrimp, spring onion, mustard greens, salted seafood sauce, red pepper, water, etc. The fermentation temperature may be appropriately varied in a range of 0-10° C. according to the kind of kimchi. In addition, the soaking time is varied according to the salinity of the salt solution. The soaking time may be the same as that used for common kimchi. However, the soaking time may be determined considering that the kimchi containing puerh tea leaves according to the present embodiment can be preserved for a longer duration at a lower salinity than common kimchi.

The mixing ratio of puerh tea leaves may be properly varied according to the kind of kimchi and the desired taste. For sour kimchi, a small amount of puerh tea leaves is added. For kimchi which does not become sour and tastes fresh for a longer time, the mixing ratio of puerh tea leaves is increased. The mixing ratio of puerh tea leaves may be in a range of 0.001-15% by weight based on the total weight of the final kimchi product. If the mixing ratio of puerh tea leaves is less than 0.001% by weight, the effect of adding the puerh tea leaves cannot be obtained. If the mixing ratio of puerh tea leaves is greater than 15% by weight, the taste of the puerh tea leaves is too strong to enjoy the natural taste of kimchi. The mixing ratio of puerh tea leaves can be is in a range of, preferably, 0.01-10% by weight, more preferably, 0.01-5% by weight.

In a conventional method, to prevent kimchi from becoming sour, the salinity of the kimchi is increased. However, salty kimchi is not beneficial in terms of taste and health. The souring of kimchi can also be prevented using sterilization, etc. However, this method adversely affects the taste by resulting in a kimchi stew-like taste.

However, the inventors have found that when puerh tea leaves are added to kimchi according to the present invention, without increasing the salinity or using high temperature sterilization, kimchi does not become sour and remains fresh for a long time.

In addition, puerh tea leaves are a healthy food resource and can be added in an unlimited amount. The flavor of puerh tea leaves makes the taste of kimchi more fresh and mild, prevents souring of the kimchi, and removes unpleasant smells produced when the kimchi ferments.

In other words, in keeping the taste of kimchi fresh and the acidity of kimchi low, puerh tea leaves used in the present invention provide prominent effects which are unexpected in conventional methods.

Hereinafter, the present invention will be described in more detail with reference to the following examples. However, the following examples are for illustrative purposes and are not intended to limit the scope of the invention.

### EXAMPLES

### Example 1

Preparation of Kakdugi with Puerh Tea Leaves

Ten radishes, each having a weight of about 1.5 kg, were cut into 1.5 cm×1.5 cm×1.5 cm cubes and soaked in saline water. The salted radishes were mixed with common kimchi spices, i.e., 500 g of red pepper powder, 300 g of garlic, 300 g of ginger, 300 g of salted shrimp source, etc., and 340 g of puerh tea leaves (produced in Yunnan province, China), and stored at 4° C. for fermentation.

### Comparative Example 1

Preparation of Common Kakdugi

Kakdugi (cubed radish kimchi) was prepared in the same manner as in Example 1, except that no puerh tea leaves were added.

Samples were taken from each of the cubed radish kimchi products prepared in Example 1 and Comparative Example 1 after storage for 2 days, 9 days, 16 days, 23 days, 30 days, 37 days, and 44 days to measure their pH and salinity. The measured pH and salinity of each of the samples are shown in Table 1.

TABLE 1

| | | PH | | Salinity (w/v %) | |
|---|---|---|---|---|---|
| Storage Time | | | Comparative | | Comparative |
| (4° C.) | | Example 1 | Example 1 | Example 1 | Example 1 |
| 2 | days | 5.52 | 6.05 | 2.38 | 1.94 |
| 9 | days | 5.75 | 5.46 | — | — |
| 16 | days | 5.76 | 4.87 | — | — |
| 23 | days | 5.71 | 4.54 | 1.83 | 1.97 |
| 30 | days | 5.95 | 4.37 | 1.84 | 1.82 |
| 37 | days | 5.59 | 4.26 | 1.44 | 1.65 |
| 44 | days | 5.19 | 4.20 | 1.49 | 1.76 |

As is apparent from Table 1, the pH levels of the cubed radish kimchi containing puerh tea leaves prepared in Example 1 at the early stage and after 44 days were similar, indicating that the cubed radish kimchi containing puerh tea leaves did not sour. However, for the common cubed radish kimchi prepared in Comparative Example 1, the pH level was much lower after 44 days. The results support that puerh tea leaves can effectively retard the souring of Kakdugi.

In addition, as is apparent from Table 1, the salinity of the cubed radish kimchi containing puerh tea leaves was lower than the salinity of the common cubed radish kimchi, indicating that puerh tea leaves give kimchi a mild taste.

### Example 2

Preparation of Baek Kimchi (White Cabbage Kimchi) with Puerh Tea Leaves

Twenty Chinese cabbages, each having a weight of about 1.5-2.0 kg, were soaked in saline water. The salted cabbages were mixed with 3000 g of shredded radish, 300 g of garlic, 300 g of ginger, 260 g of green onion, 600 g of mustard greens, and a small amount of salt, and then 680 g of puerh tea leaves (produced in Yunnan province, China) were added thereto. White cabbage kimchi was prepared using the resultant mixture according to a common method and stored at 4° C. for fermentation.

### Comparative Example 2

Preparation of Common Baek Kimchi (White Cabbage Kimchi)

White cabbage kimchi was prepared in the same manner as in Example 2, except that no puerh tea leaves were added.

Samples were taken from each of the kimchies prepared in Example 2 and Comparative Example 2 after storage for 2 days, 9 days, 16 days, 23 days, 30 days, 37 days, and 44 days to measure their pH and salinity. The measured pH and salinity of each of the samples are shown in Table 2.

TABLE 2

| | | PH | | Salinity (w/v %) | |
|---|---|---|---|---|---|
| Storage Time | | | Comparative | | Comparative |
| (4° C) | | Example 2 | Example 2 | Example 2 | Example 2 |
| 2 | days | 5.82 | 5.83 | 2.06 | 2.22 |
| 9 | days | 5.58 | 4.41 | — | — |
| 16 | days | 5.39 | 4.35 | — | — |
| 23 | days | 5.35 | 4.23 | 1.66 | 1.42 |
| 30 | days | 5.22 | 4.33 | 1.24 | 0.77 |
| 37 | days | 4.77 | 4.25 | 1.7 | 1.3 |
| 44 | days | 4.65 | 4.19 | 1.78 | 1.78 |

As is apparent from Table 2, the change in pH level of the white cabbage kimchi containing puerh tea leaves prepared in Example 2 over time was smaller than the change in pH level of the common white cabbage kimchi of Comparative Example 2 over time, and the final white cabbage kimchi containing puerh tea leaves of Example 2 was less sour than the common white cabbage kimchi of Comparative Example 2, indicating that puerh tea leaves can effectively retard the souring of white cabbage kimchi.

In addition, as is apparent from Table 2, although the acidity of the white cabbage kimchi containing puerh tea leaves was lower than the acidity of the common white cabbage kimchi, the salinity of the white cabbage kimchi containing puerh tea leaves was not greater than the common cabbage kimchi. Therefore, it is evident that puerh tea leaves can effectively maintain a non-sour, fresh, and mild taste of kimchi at low salinity.

### Example 3

Preparation of Cabbage Kimchi with Puerh Tea Leaves

Twenty Chinese cabbages, each having a weight of about 1.5-2.0 kg, were socked in saline water.

The salted cabbages were mixed with 1200 g of red pepper powder, 3000 g of shredded radish, 300 g of garlic, 300 g of ginger, 260 g of green onion, 600 g of mustard greens, and 300 g of salted shrimp sauce, and then 1360 g of puerh tea leaves (produced in Yunnan, China) were added thereto. Cabbage kimchi was prepared using the resultant mixture according to a common method and stored at 4° C. for fermentation.

### Example 3-1

Preparation of Cabbage Kimchi with Puerh Tea Leaves

Cabbage kimchi was prepared in the same manner as in Example 3, except that 680 g of puerh tea leaves was used.

### Comparative Example 3

Preparation of Common Cabbage Kimchi

Common cabbage kimchi was prepared in the same manner as in Example 3, except that no puerh tea leaves was added.

Samples were taken from each of the kimchies prepared in Example 3, Example 3-1, and Comparative Example 3 after storage for 2 days, 9 days, 16 days, 23 days, 30 days, 37 days, and 44 days to measure their pH and salinity. The measured pH and salinity of each of the samples are shown in Table 3.

TABLE 3

| | | PH | | | Salinity (w/v %) | | |
|---|---|---|---|---|---|---|---|
| | | | | Compara- | | | Compara- |
| Storage | | Exam- | Exam- | tive | Exam- | Exam- | tive |
| Time | | ple | ple | Example | ple | ple | Example |
| (4° C) | | 3 | 3-1 | 3 | 3 | 3-1 | 3 |
| 2 | days | 5.37 | 5.46 | 5.66 | 2.75 | 2.42 | 2.27 |
| 9 | days | 5.3 | 5.29 | 4.73 | — | — | — |
| 16 | days | 5.42 | 5.03 | 4.87 | — | — | — |
| 23 | days | 5.28 | 4.65 | 4.36 | 2.03 | 1.9 | 2.58 |
| 30 | days | 5.23 | 4.88 | 4.47 | 1.91 | 1.77 | 2.5 |
| 37 | days | 5.11 | 4.55 | 4.23 | 1.76 | 1.5 | 2.35 |
| 44 | days | 4.74 | 4.61 | 4.16 | 1.62 | 1.47 | 2.35 |

As is apparent from Table 3, comparing the cabbage kimchies prepared with different amounts of puerh tea leaves in Example 3 and Example 3-1, the pH level of the cabbage kimchi containing a large amount of puerh tea leaves decreased less. In addition, the changes in pH level of the cabbage kimchies containing puerh tea leaves prepared in Example 3 and Example 3-1 were smaller than the change in pH level of the common cabbage kimchi of Comparative Example 3, indicating that puerh tea leaves can effectively retard the souring of cabbage kimchi.

In addition, as is apparent from Table 3, puerh tea leaves can effectively lower the salinity of cabbage kimchi. In particular, although the acidities of the cabbage kimchies containing puerh tea leaves (Example 3 and Example 3-1) are lower than the acidity of the common cabbage kimchi, the salinities of the cabbage kimchies containing puerh tea leaves are lower than the salinity of the common cabbage kimchi and thus taste fresh and mild. The fresh taste of the cabbage kimchies containing puerh tea leaves was maintained because puerh tea leaves removed unpleasant smells produced during storage for a long time.

### Example 4

Preparation of Radish Kimchi in Water (Dongchimi) with Puerh Tea Leaves

500 g of salt, 100 g of garlic, 100 g of ginger, 100 g of green onion, 100 g of mustard greens, 100 g of peppers, and 20 L of water were added to 50 radishes, each having a weight of about 1.5 kg, and 680 g of puerh tea leaves (produced in Yunnan province, China) were added thereto. Radish kimchi in water was prepared using the resultant mixture according to a common Dongchimi preparation method and stored at 4° C. for fermentation.

### Comparative Example 4

Preparation of Common Donqchimi

Radish kimchi in water (Dongchimi) was prepared in the same manner as in Example 4, except that no puerh tea leaves was added.

Samples were taken from each of the Dongchimi products prepared in Example 4 and Comparative Example 4 after storage for 2 days, 9 days, 16 days, 23 days, 30 days, 37 days, and 44 days to measure their pH and salinity. The measured pH and salinity of each of the samples are shown in Table 4.

TABLE 4

| | | PH | | Salinity (w/v %) | |
|---|---|---|---|---|---|
| Storage Time | | | Comparative | | Comparative |
| (4° C) | | Example 4 | Example 4 | Example 4 | Example 4 |
| 2 | days | 5.93 | 6.18 | 1.69 | 2.09 |
| 9 | days | 5.6 | 5.3 | — | — |
| 16 | days | 5.48 | 4.45 | — | — |
| 23 | days | 5.43 | 3.98 | 1.54 | 1.3 |
| 30 | days | 6.26 | 3.96 | 1.12 | 1.12 |
| 37 | days | 5.52 | 3.83 | 1.21 | 1.44 |
| 44 | days | 5.66 | 3.86 | 1.24 | 1.48 |

As is apparent from Table 4, puerh tea leaves had effects on the radish kimchi in water. As a result of measuring the pH levels of the Dongchimi containing puerh tea leaves of Example 4 and the common Dongchimi of Comparative Example 4, it was found that the souring of the Dongchimi of Example 4 was markedly retarded relative to the common Dongchimi. In addition, the puerh tea leaves effectively lowered the salinity of Dongchimi.

As described in the above examples and comparative examples, puerh tea leaves effectively retard the souring of kimchi and lower the salinity of kimchi. These effects of puerh tea leaves are attributed to the inherent neutralization effect of puerh tea leaves. In general, kimchi becomes sour as the salinity of the kimchi becomes low. However, when puerh tea leaves are added, kimchi does not sour and is maintained fresh at low salinity for a long time.

### Experimental Example 1

To measure the acidity and texture of each of the kimchi products of the above-described examples and comparative examples after storage for 42 days, sensory tests on sour taste and texture preference were performed using a panel 30 untrained taste testers. The results are shown in Tables 5 and 6.

TABLE 5

| | | Slightly | Moderately | | Extremely |
|---|---|---|---|---|---|
| | Not Sour | Sour | Sour | Very Sour | Sour |
| Example 1 | 2 | 6 | 22 | — | — |
| Comparative | — | — | 2 | 16 | 12 |
| Example 1 | | | | | |
| Example 2 | 4 | 14 | 12 | — | — |
| Comparative | — | 1 | 11 | 15 | 3 |
| Example 2 | | | | | |
| Example 3 | — | 13 | 17 | — | — |
| Example 3-1 | — | 16 | 14 | — | — |
| Comparative | — | — | 1 | 19 | 10 |
| Example 3 | | | | | |
| Example 4 | 6 | 18 | 6 | — | — |
| Comparative | — | 8 | 21 | 1 | — |
| Example 4 | | | | | |

Note)
Values indicate the numbers of panel members who indicated the corresponding sourness.

TABLE 6

| | Texture Preference (5-point scale) | | | | |
|---|---|---|---|---|---|
| | 1 | 2 | 3 | 4 | 5 |
| Example 1 | — | 1 | 20 | 6 | 3 |
| Comparative | — | 9 | 16 | 4 | 1 |
| Example 1 | | | | | |
| Example 2 | — | — | 12 | 16 | 2 |
| Comparative | 1 | 15 | 8 | 6 | — |
| Example 2 | | | | | |
| Example 3 | — | 2 | 18 | 9 | 1 |
| Example 3-1 | — | 3 | 18 | 9 | — |
| Comparative | — | 18 | 9 | 3 | — |
| Example 3 | | | | | |

Note)
Values indicate the numbers of panel members who indicates the corresponding texture preference.

As is apparent from Tables 5 and 6, the overall texture preference was high and the level of sourness was suitable for the kimchies containing puerh tea leaves. This is because the puerh tea leaves suppressed the souring of kimchi, maintained the texture of kimchi to be crispy, removed off-flavors of the kimchi, controlled moisture content, and maintained the taste of kimchi to be fresh.

Kimchi containing puerh tea leaves according to the present invention does not undergo flavor changes, such as souring, and texture degradation. In addition, the puerh tea leaves in the kimchi remove off-flavors produced during fermentation, thereby maintaining fresh and mild taste of the kimchi.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. Kimchi prepared using vegetables, the kimchi containing 0.001-15% by weight of puerh tea leaves based on the total weight of the kimchi.

2. The kimchi of claim 1 being a kimchi from the group consisting of Chinese cabbage kimchi, cubed radish kimchi (Kakdugi), young radish kimchi, mustard green kimchi, white cabbage kimchi, western cabbage kimchi, winter-grown vegetable kimchi, radish kimchi in water (Dongchimi), cabbage kimchi in water, stuffed cucumber pickles, lettuce kimchi, leek kimchi, and cucumbers pickled in salt.

3. A method of preparing kimchi containing puerh tea leaves, the method comprising:
soaking vegetables in saline water;
mixing the vegetables with puerh tea leaves and common kimchi spices; and
fermenting the mixture.

4. The method of claim 3, wherein the vegetables are selected from the group consisting of Chinese cabbage, radishes, young radishes, mustard greens, western cabbage, winter-grown vegetables, cucumbers, lettuce, and leeks.

5. The method of claim 3, wherein the fermenting is performed at a temperature of 0-10° C.
